(19) United States
(12) Patent Application Publication
(10) Pub. No.: US 2021/0106162 A1
(43) Pub. Date: Apr. 15, 2021

(54) POUR OVER TYPE SYSTEMS AND METHODS FOR SEPARATING AN EXTRACT FROM A SUSPENSION

(71) Applicant: ESPRO, Inc., Vancouver (CA)

(72) Inventors: Cary Ong, Richmond (CA); Christopher R. McLean, Vancouver (CA); Bruce A. Constantine, North Attleboro, MA (US); Jordan Sciberras, Vancouver (CA)

(21) Appl. No.: 17/037,786

(22) Filed: Sep. 30, 2020

Related U.S. Application Data
(63) Continuation of application No. PCT/US20/46971, filed on Aug. 19, 2020.
(60) Provisional application No. 62/942,613, filed on Dec. 2, 2019.
(60) Provisional application No. 62/889,007, filed on Aug. 19, 2019.

(51) Int. Cl. A47J 31/02; A47J 31/44; A47J 31/08; A47J 31/06; B01D 29/085

(52) U.S. Cl. CPC A47J 31/02; A47J 31/4457; A47J 31/08; A47J 2203/00; B01D 29/085; A47J 2031/0694; B01D 2201/12; A47J 31/0631

(57) ABSTRACT

The present disclosure includes many embodiments of devices and related methods for creating an infused extract from a mixture of infusible material and one or more liquids using “pour-over” type methodologies. Any desired infusible material can be used, as well as any desired combination of liquids.

### CROSS-REFERENCE TO RELATED APPLICATIONS

The present patent application is a continuation of and claims the benefit of priority to International Application No. PCT/US2020/46971 filed Aug. 19, 2020, which in turn claims the benefit of priority to U.S. Provisonal Patent Application Ser. No. 62/942,613, filed Dec. 2, 2019, and U.S. Provisional Patent Application Ser. No. 62/889,007, filed Aug. 19, 2020. This patent application is also related to U.S. patent application Ser. No. 29/702,441, filed Aug. 19, 2019, U.S. patent application Ser. No. 29/715,472, filed Dec. 2, 2019, and U.S. patent application Ser. No. 29/715,468, filed Dec. 2, 2019. Each of the foregoing patent applications is hereby incorporated by reference herein in its entirety for all purposes.

### FIELD

The present disclosure relates generally to apparati capable of carrying out an extraction of an infusible material and related methods, and more particularly to systems for extracting an infusion such as from coffee or tea.

### BACKGROUND

“Pour over” systems for extracting an infusion have been around for decades. In such systems, an infusible material is placed in an infusing container of some kind that in turn is typically placed on top of a drinking vessel. Hot water or other liquid is then “poured over” or otherwise introduced into the infusing container on top of the infusible material, and the liquid is permitted to form an infusion (e.g., coffee or tea). The resulting infusion then permitted to progress through the infusible material and sometimes one or more filter media under the action of gravity and then exits the infusing container and drips downwardly into the drinking vessel.

A main function of these extraction systems is to ensure a separation between bulk infusible material such as coffee grinds and tea leaves, from an extract intended for consumption. While many different designs have been implemented, there is still room for improvement in achieving optimal performance. The present disclosure improves upon the state of the art.

### SUMMARY

Advantages of the present disclosure will be set forth in and become apparent from the description that follows. Additional advantages of the disclosure will be realized and attained by the methods and systems particularly pointed out in the written description and claims hereof, as well as from the appended drawings.

The present disclosure includes many embodiments of devices and related methods for creating an infused extract from a mixture of infusible material and one or more liquids. Any desired infusible material can be used, as well as any desired combination of liquids.

Various embodiments are provided herein of an extract separation apparatus that are useful for separating an infused extract from a mixture of an infusible material and the extract. The apparatus can typically include an infusion container made of any of a variety of materials, including metals (e.g., stainless steel, copper, aluminum, magnesium, and the like), plastics (e.g., ABS, polyethylene terephthalate, acrylic, polypropylene, and the like), and/or composite materials, such as fiber reinforced resins, ceramics, combinations of these materials, and the like.

The infusing container can have an integral filter or a removable filter and/or a disposable filter. The infusing container can be cylindrically shaped, conically shaped and the like and have a circular cross section in some illustrated embodiments, but the infusing container may alternatively have a polygonal, curved or undulating cross-section, as desired. If provided, an integral filter can form a bottom surface of the infusing container defining a plurality of openings therethrough. Whether or not an integral filter is included, a disposable (e.g., paper or polymeric) filter can be used additionally. Experience has shown that brews made using pour over infusing containers made in accordance with the present disclosure can achieve high clarity and/or more body, depending on the configuration of the filtration used. The disclosed embodiments can work well with off-the-shelf ground coffee and provide even extraction.

In some implementations, the infusing container can include a double wall to decrease heat transfer in a radially outward direction from a heated mixture of infused extract and infusible material disposed within the infusing container. This design is particularly suitable for being NSF (National Sanitation Foundation) compliant for food-service applications. The disclosed embodiments have been shown to provide even extraction, fast brew time with reduced heat loss. Some implementations provide for a cylindrical coffee bed that can allow for very even extraction of coffee as all the water introduced into the infusing container effectively contacts about the same amount of coffee, wherein the coffee bed has an even thickness. This is in contrast to other previous designs in the art that permits water to exit the coffee bed very early.

Various implementations of infusion containers disclosed herein are typically provided with a large number of orifices or holes defined therethrough distributed in various patterns to encourage even flow and even extraction.

Some implementations in accordance with the disclosure define a cylindrical coffee bed in use, and may additionally or alternatively include a perforated bottom wall that may be planar or downwardly curved. This can encourage a flat top surface on the resulting coffee bed after brewing, which is a leading indicator of even extraction to a user. In particular, a convex lower exit surface of the filter element encourages liquid to adhere to the surface and drip downwardly toward the center of the filter element by way of the Coanda effect. Directing the infused extract toward the center of the lower facing surface of the filter element creates a single stream of fluid with a relatively low surface area, further reducing heat loss from the infused extract as contrasted with a filter surface that develops multiple, relatively smaller streams that have a higher collective ratio of volume to surface area, or Biot number. In some illustrated embodiments, a curved metal filter gathers all finished infused extract into one stream that drops from the central bottom location of the infusing container.

Embodiments made in accordance with the disclosure facilitate faster extraction, which also helps reduce heat loss. Faster extraction and throughput of the disclosed embodiments permits more thermal energy to remain in the coffee.

Some embodiments can include a partial or full external polymeric/dielectric (e.g. silicone) coating to provide enhanced thermal insulation during brewing. The coating can be located in a grip region to permit a user to grasp a portion of the infusing container while its contents are still hot. Some embodiments of the infusing container can include a double wall that defines a gap there-between along all or some of the circumferential extent of the infusing container. The gap can be an air gap or dead air space to enhance thermal resistance along a radially outward direction. The gap can also be at least partially occupied by a thermally resistant material, such as a dielectric or other insulating material (e.g., silicone).

In some implementations, the peripheral wall of the infusing container can be conical or otherwise tapered radially outwardly or funnel shaped. Some embodiments include a wall angle that is relatively steep (e.g., between 10 and 35 degrees from vertical, or any angle therebetween of about one degree inclusive of the endpoints of said range). This is typically steeper than infusing containers known in the art. This has the net effect, for a given volume of infused extract, to result in a taller water column and enhanced hydrostatic pressure within the coffee bed and filter element to drive flow through the infusing container.

The filter element, such as a permanent (e.g., metal) filter element preferably defines opening therethrough that occupy at least 5 percent of its surface area, 6, 7, 8, 9, 10 or more percent of its surface area, for example. This can be provided, for example, by providing precision punched holes through the filter element to allow greater flow to speed up brewing time and reduce heat loss. In other implementations, holes can be fabricated at least in part by other methods. For example, if desired, the holes can be chemically etched, laser cut and the like. The openings through the filter element can be any shape or size. In some implementations, the filter openings can be non-cylindrical along all or a portion of their lengths. For example, the openings can be conical and flare open toward the lower surface of the filter element to enhance siphoning at the lower surface of the filter element due to surface tension effects, further speeding flow and extraction, and reducing heat loss from the liquid, as well as making the openings easier to clean.

The peripheral wall of the infusing container can be conical or otherwise funnel shaped, and be provided with one or more inflection or bend points at which the angle of taper increases. These bend points can form peripheral lines or indicia that can be used as indicia to mark, for example, the level to which coffee grounds should be added to form the coffee bed, and also the level to which the infusing container should be filled with hot water after the coffee has been added. Such indicia can also provide a physical target at which to aim for a user to aim for when performing a swirling motion when dispensing water into the infusing container.

In some implementations, one or more bypass ports or openings can be provided through a support disc that supports the infusing container over a second container to permit a user to perform bypass brewing wherein the user can dilute the infused extract by adding water directly into the second container to infused extract formed by the infusing container. The bypass port can also permit the user to see the level of infused extract in the second container to help to prevent overfilling. The support disc or plate at or near the bottom of the infusing container can include a peripheral flange formed, for example by a rolled lip or other atraumatic surface or shape to enhance safety. If provided in the form of a rolled edge, the rolled edge can include an overmolded layer to enhance sanitation and/or for aesthetic purposes.

A filter paper can additionally be used to enhance filtration by disposing the filter paper in the infusing container prior to adding coffee grounds or other infusible material. A relatively large number of flutes can be provided in the filter to make each individual flute relatively smaller and help to prevent the clogging of the flutes.

It is to be understood that the foregoing general description and the following detailed description are illustrative and are intended to provide further explanation of the disclosed embodiments. The accompanying drawings, which are incorporated in and constitute part of this specification, are included to illustrate and provide a further understanding of the disclosed methods and systems. Together with the description, the drawings serve to explain principles of the disclosure.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIGS. 1A-1B are top and isometric views, respectively, of a first representative embodiment of a system for forming an infused extract in accordance with the present disclosure.

FIG. 1C presents an isometric view of a second embodiment of a system for forming an infused extract in accordance with the present disclosure

FIGS. 2A-2B show a side view and a cross sectional view, respectively, of the embodiment of FIGS. 1A-1B.

FIGS. 3A-3B are top and isometric views, respectively, of a portion of a third representative embodiment of a system for forming an infused extract in accordance with the present disclosure.

FIGS. 4A-4B show a side view and a cross sectional view, respectively, of the embodiment of FIG. 3 in a fully assembled form.

FIGS. 5A-5B are isometric and planar cut away views of the embodiment of FIGS. 1A-1B showing placement of an infusible material in accordance with the present disclosure.

FIG. 6 is a cross sectional view of a drain orifice in a filter element in accordance with the present disclosure.

FIG. 7 is an isometric view of an orifice distribution pattern of a filter element in accordance with the present disclosure.

FIG. 8A is a top view of an embodiment of an infusion chamber in accordance with the present disclosure including a pleated filter element disposed therein having infusible material. Further views of the illustrated filter element are depicted in FIGS. 8B-8F. FIG. 8G-8H illustrate aspects of the interaction between a thermal sleeve as illustrated in FIGS. 12A-12B disposed on the system illustrated in FIG. 1B and a flared filter element.

FIG. 9 is a cross sectional view of the embodiment of FIGS. 1A-1B illustrating indicia formed into the illustrated infusing container in accordance with the present disclosure.

FIG. 10 is an isometric view of an infusing container in accordance with the present disclosure disposed over a second container to receive an infused extract.

FIG. 11 is a cross sectional view of the embodiment of FIGS. 1A-1B having a rolled atraumatic peripheral edge.

FIGS. 12A-12B illustrate aspects of a dielectric sleeve in accordance with the present disclosure.

FIG. 13 is an isometric view of a scoop in accordance with the present disclosure displaying an instructive indicia.

FIGS. 14A-14D depicts isometric view of illustrative carafes and a lid in accordance with the present disclosure.

FIGS. 15A-15B depict bottom isometric and cross sectional views of the lid depicted in FIG. 14.

### DESCRIPTION

Reference will now be made in detail to the present preferred embodiments of the disclosure, examples of which are illustrated in the accompanying drawings. The methods and corresponding steps of the disclosed embodiments will be described in conjunction with the detailed description of the disclosed devices.

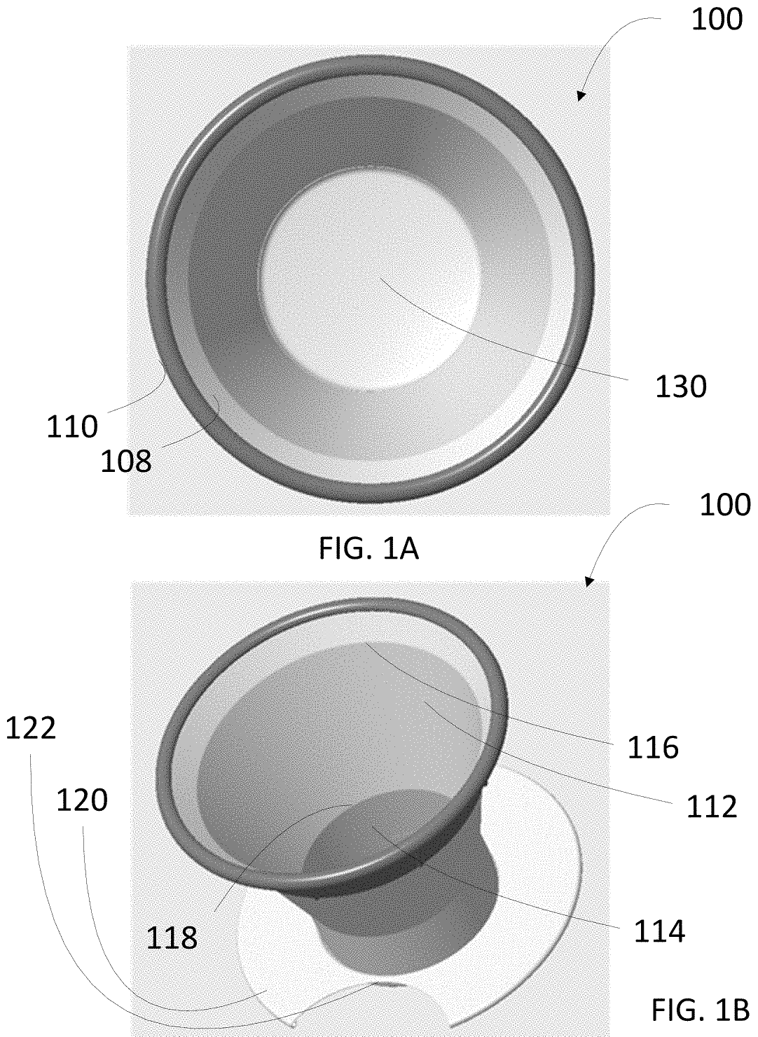

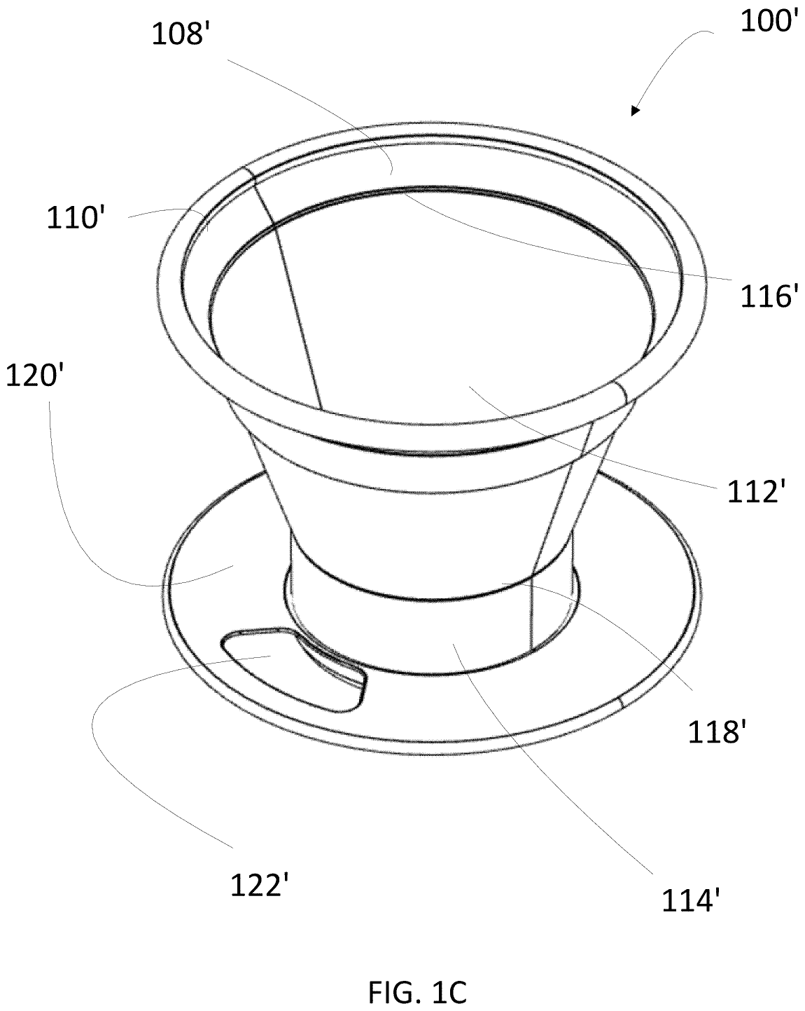

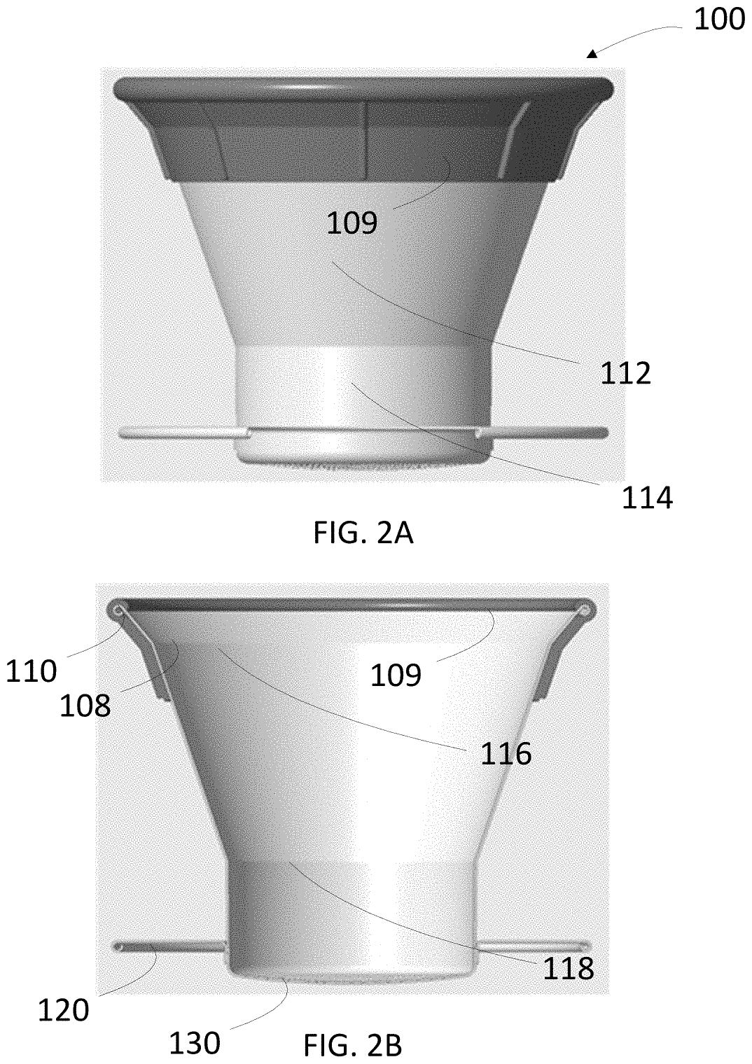

In accordance with the disclosure, FIGS. 1A-1B are top and isometric views, respectively, of a first representative embodiment of a system for forming an infused extract in accordance with the present disclosure. FIGS. 2A-2B show a side view and a cross sectional view, respectively, of the embodiment of FIG. 1.

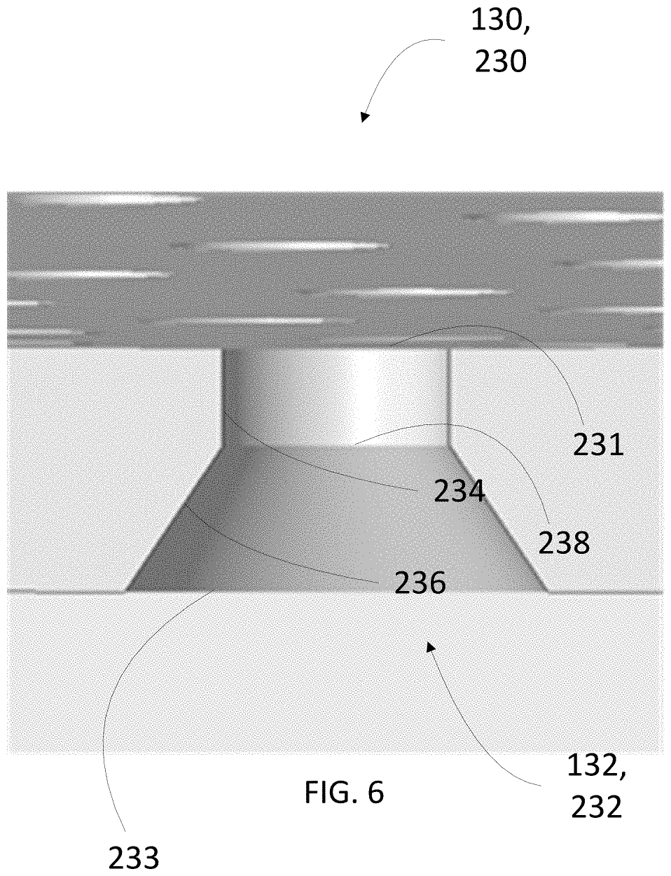

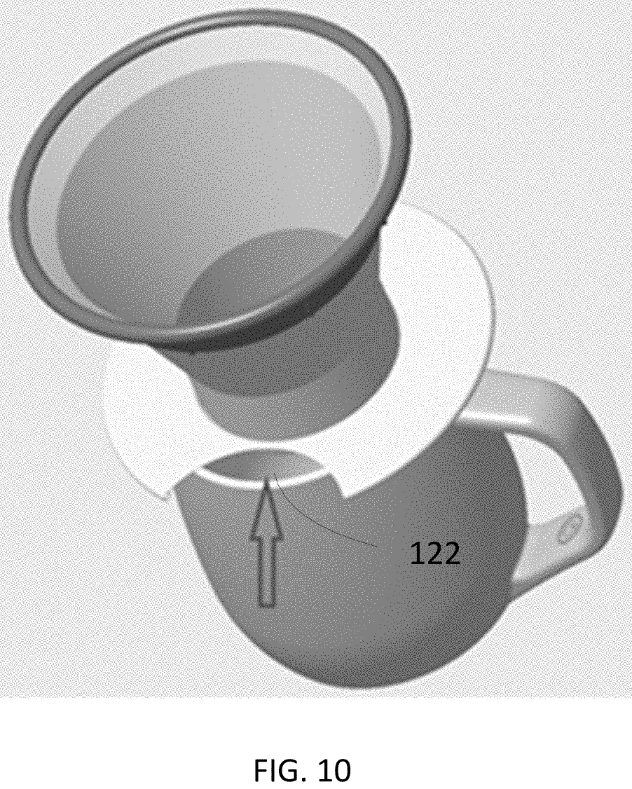

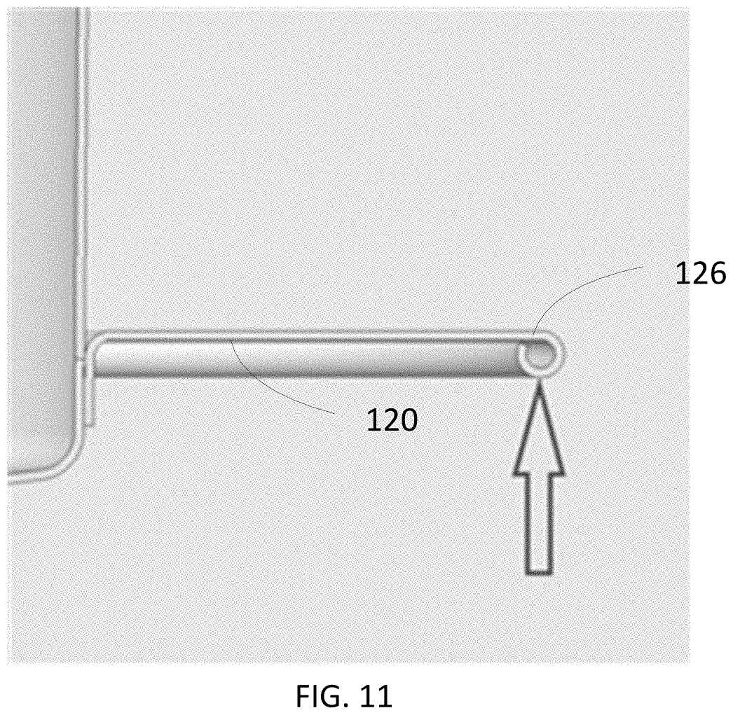

As illustrated, an infusing container 100 is depicted formed from an inner vessel having a compound shape formed from a cylinder and one or more intersecting conic sections. Container 100 includes an upper peripheral flange 110 that may include an insulating overmolded layer 109 (formed, for example, from a dielectric material such as plastic, wood or the like) to permit a user to hold or otherwise grip the flange when it includes hot contents. The overmolded layer can be overmolded onto the material of the container or can be molded separately and attached to the container by adhesive, or just by frictional forces. As illustrated, the layer 109 traverses upwardly along the side of the container, and traverses around a rolled edge of the upper peripheral flange and downwardly to surround the flange 110, and project radially inwardly into the container 100 to some extent. Flange 110 transitions into a first conical surface 108 that in turn transitions along an inflection line 116 to a second conical surface 112. Conical surface 112 in turn traverses downwardly and transitions along a second inflection line 118 to a generally cylindrical wall 114. The sections 108, 112, 114 can be shaped as indicated, or the peripheral wall may have a continuous curve such that it is a concave or convex bell shape. Wall section 114 depends downwardly and transitions into a floor section 130 that includes a plurality of perforations 132, 232 disposed therein (FIG. 6). An annular disc or plate 120 surrounds and is attached to a lower external portion of wall 114. Plate 120 includes a crescent shaped or arcuate notch 122 formed therein to permit a user to view the fluid level in a second container when the infusing container is in use, and to permit a user to dilute infused extract with water or to introduce other additives (FIG. 10). If formed from a sheet of metal, for example, plate 120 can have a circumferential periphery that terminates in an atraumatic rolled edge 126 (FIG. 11) that can be overmolded with a dielectric or other material (not shown).

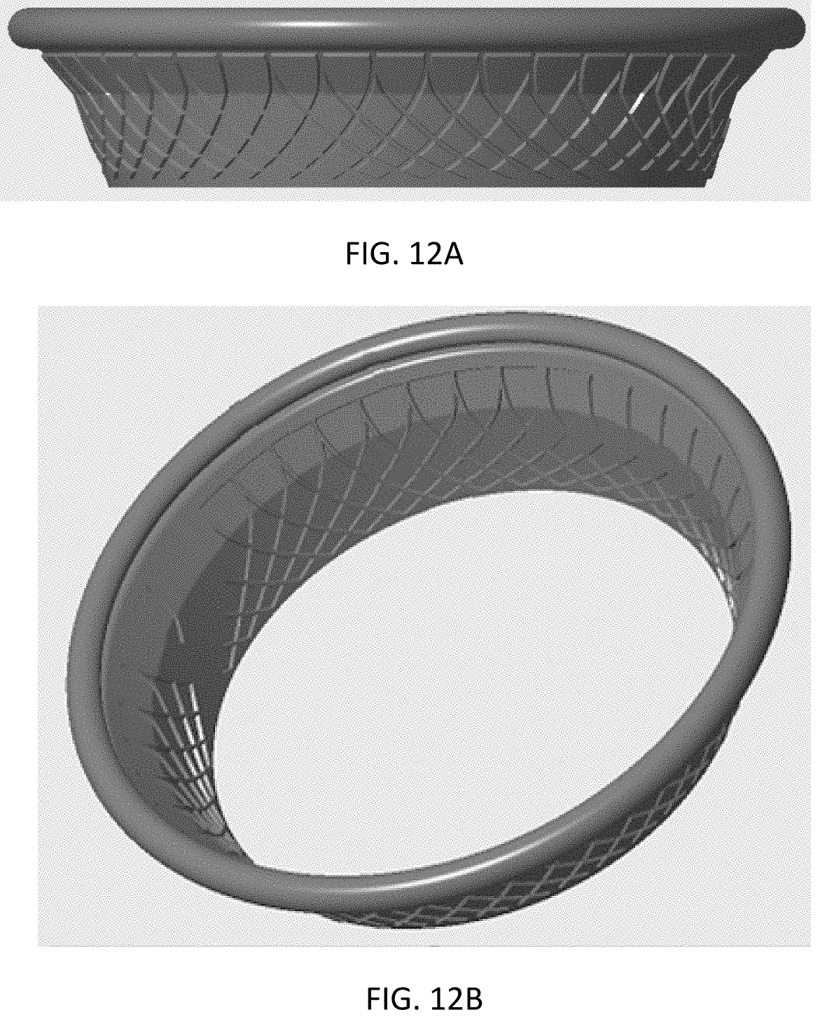

FIG. 1C illustrates a further embodiment of an infusing container 100′ formed from an inner vessel having a compound shape formed from a cylinder and one or more intersecting conic sections, as with the previous embodiment. Container 100′ includes an upper peripheral flange that may similarly include an insulating overmolded layer (formed, for example, from a dielectric material such as plastic, wood or the like), or a removable sleeve such as that depicted in FIGS. 12A-12B to permit a user to hold or otherwise grip the flange when the container 100′ includes hot contents. The upper peripheral flange 110′ transitions into a first conical surface 108′ that in turn transitions along an inflection line 116 to a second conical surface 112′. Conical surface 112′ in turn traverses downwardly and transitions along a second inflection line 118′ to a generally cylindrical wall 114′. The sections 108′, 112′, 114′ can be shaped as indicated, or the peripheral wall may have a continuous curve such that it is a convex bell shape. Wall section 114′ depends downwardly and transitions into a floor section that includes a plurality of perforations disposed therein (as illustrated in FIG. 6). An annular disc or plate 120′ surrounds and is attached to a lower external portion of wall 114′. Plate 120′ defines therein a generally trapezoidally shaped opening, or window 122′ to permit a user to view the fluid level in a second container when the infusing container is in use, and to permit a user to dilute infused extract with water or to introduce other additives (FIG. 10). If formed from a sheet of metal, for example, plate 120′ can have a circumferential periphery that terminates in an atraumatic rolled edge (FIG. 11) that can be overmolded with a dielectric or other material (not shown).

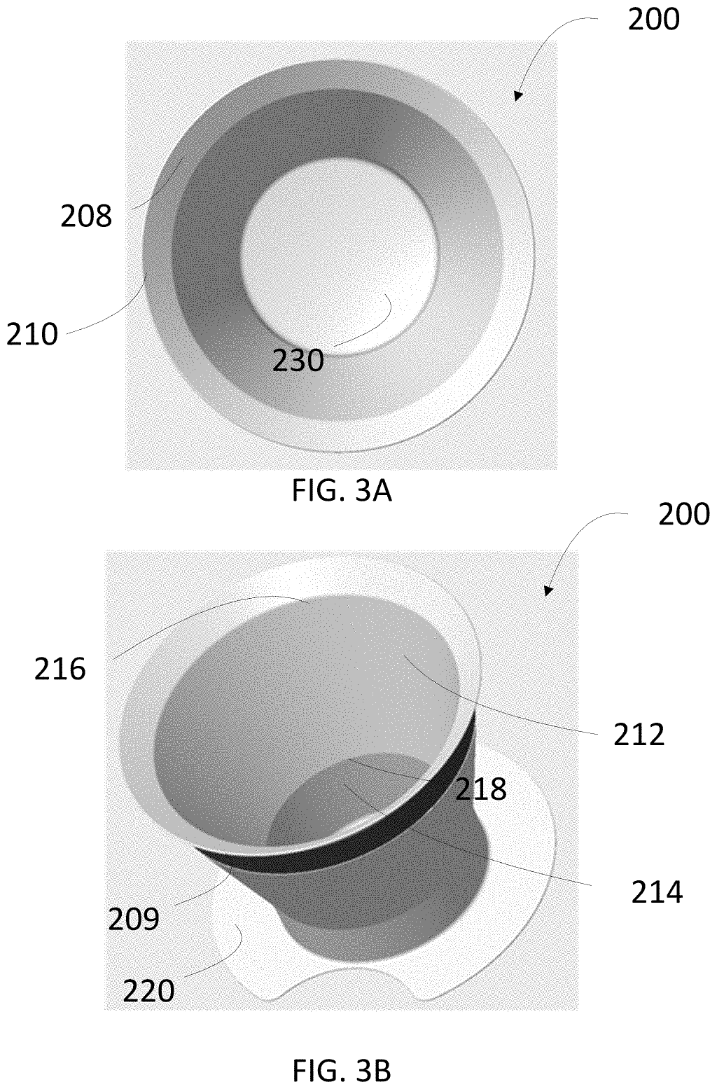

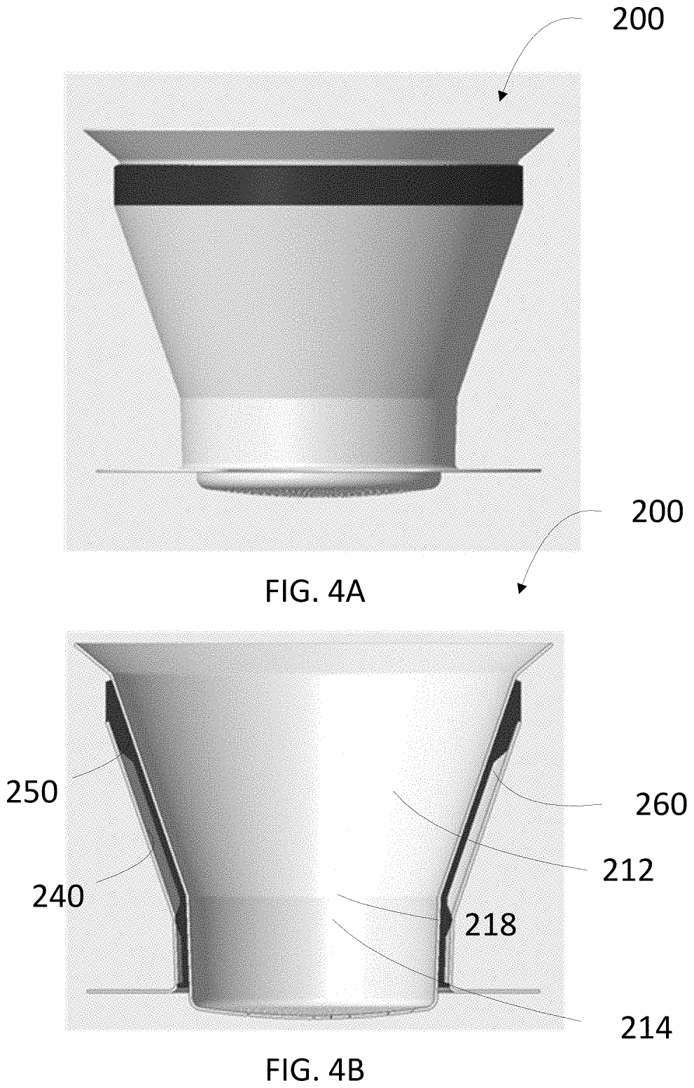

FIGS. 3A-3B are top and isometric views, respectively, of a portion of a second representative embodiment of a system for forming an infused extract in accordance with the present disclosure. FIGS. 4A-4B show a side view and a cross sectional view, respectively, of the embodiment of FIG. 3 in an assembled form.

As illustrated, embodiment 200 has a number of the same features as that of FIGS. 1A-2B bearing like reference numbers. However, embodiment 200 differs from embodiment 100 in that it is of two piece construction, wherein an inner container (FIGS. 3A-3B) bears the same or similar components to embodiment 100, with the exception of the plate 120. Instead, as illustrated in FIGS. 4A-4B, an outer sleeve 240 is provided that in turn bears disc or plate 220. The inner component and outer sleeve of embodiment 200 can be permanently affixed to each other or may be separable for cleaning. The inner and outer components of embodiment 200 cooperate to form a cavity therebetween such as an annular cavity 260 that can act as a dead air space and/or be wholly or partially filled with a dielectric material 250 in order to enhance thermal resistance to maintain the contents of the infusing container 200 at a higher temperature. The dielectric material 250 may be specially configured so as to incorporate air cavities into it to enhance thermal resistance. As illustrated in FIGS. 12A-12B, the dielectric material sleeve the sleeve itself can be textured in a projected Fibonacci spiral pattern or other desired pattern, with protrusions on the exterior surface to provide grip, and matching pockets on the interior surface to provide air gap insulation.

All of the infusing containers herein can be made from a variety of materials such as metal, plastic and the like. The filter element 130, 230 can be integral or removable, as desired. In some implementations, the peripheral wall of the infusing container can be conical or otherwise tapered radially outwardly or funnel shaped. Some embodiments include a wall angle that is relatively steep (e.g., between 10 and 35 degrees from vertical, or any angle therebetween of about one degree inclusive of the endpoints of said range). This is typically steeper than infusing containers known in the art. This has the net effect, for a given volume of infused extract, to result in a taller water column and enhanced hydrostatic pressure within the coffee bed and filter element to drive flow through the infusing container.

The infusing containers can be any desired diameter (when circular, as depicted) having a diameter between about one inch and thirty six inches, for example, or any diameter therebetween in increments of about one half of an inch (1.0, 1.5, 2.0 . . . 19, 19.5, 20, 20.5 . . . 35.5, 36 inches). Thus, the infusing containers may be sized for personal use for brewing one cup of coffee or other beverage, or can be 20 inches in diameter for institutional or commercial use, as another example. It will be appreciated further that the infusing container may be polygonal in cross section, have an undulating cross-section, and the like.

Various embodiments are provided herein of an extract separation apparatus that are useful for separating an infused extract from a mixture of an infusible material and the extract. The apparatus can typically include an infusion container made of any of a variety of materials, including metals (e.g., stainless steel, copper, aluminum, magnesium, and the like), plastics (e.g., ABS, polyethylene terephthalate, acrylic, polypropylene, and the like), and/or composite materials, such as fiber reinforced resins, ceramics, combinations of these materials, and the like.

The filter elements in accordance with the present disclosure (e.g., 130, 230) may additionally be used in any type of brewing apparatus, such as espresso machines, traditional drip coffee makers, coffee presses, and the like. The disclosed embodiments may be modified with a suitable coupling at an upper end thereof to couple to an espresso machine. Thus, the present disclosure includes the disclosed infusion apparatus, as well as any electric or non-electric brewing apparatus that includes a filter made in accordance with the present disclosure or any electric or non-electric brewing apparatus that can receive a suitably configured infusion container as disclosed herein.

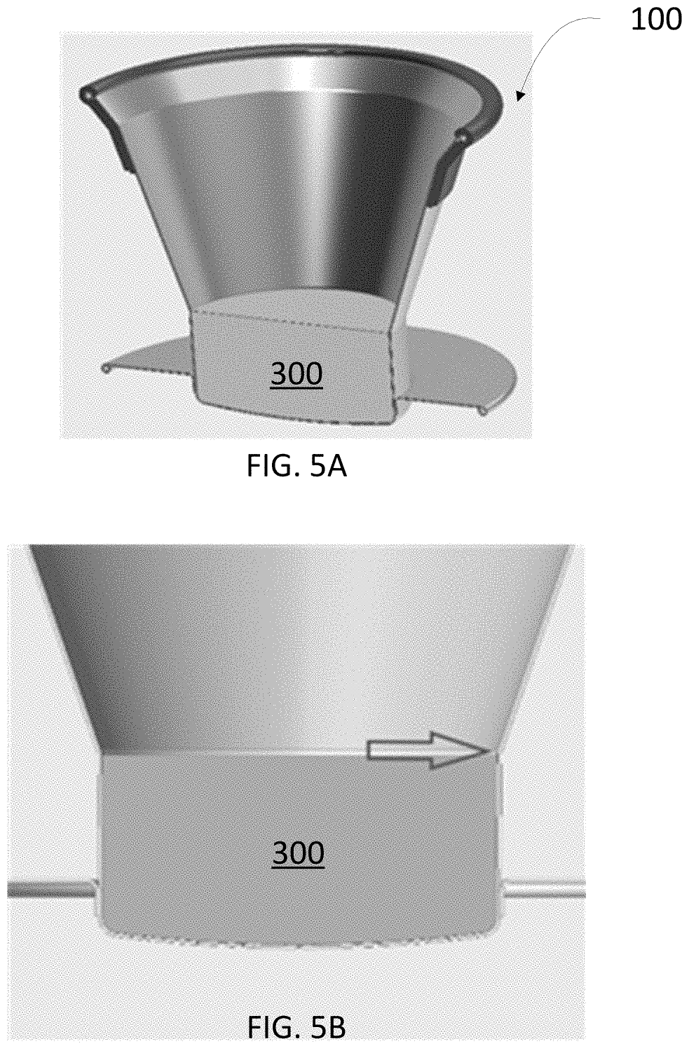

FIGS. 5A-5B are isometric and planar cut away views of the embodiment of FIG. 1 showing placement of an infusible material in accordance with the present disclosure. As illustrated, a coffee bed 300 is formed in the cylindrical section of the device, the occurrence of which tends to demonstrate a successful and even extraction procedure. The convex downwardly facing surface of the filter element 130 is readily perceptible which causes infused extract to hug the lower facing surface of the filter element 130 to permit it to form into a stream at a center thereof. If desired, a further flow guide, such as in the form of a boss, bump or other protrusion can be provided that depends directly downwardly from the centerpoint or other predetermined location on the filter element 130 to help the extract form a downward collimated stream.

FIG. 6 is a cross sectional view of a drain orifice in a filter element 130, 230 in accordance with the present disclosure. While the orifice(s) 132, 232 passing through the filter element 130, 230 can have any desired cross sectional shape and cross sectional area along their length, the depicted orifices 132, 232 are defined by an upper cylindrical wall 238 that transitions to a conical wall 236 at an inflection line 238. Each orifice 132, 232 has an upper opening 231 and a lower exit 233.

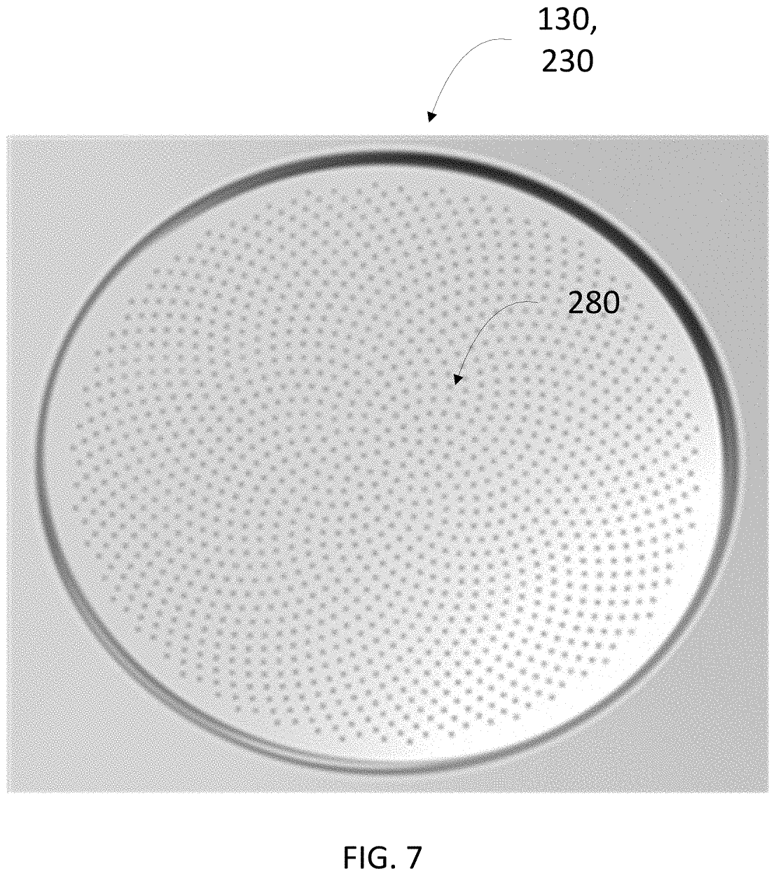

FIG. 7 is an isometric view of an orifice distribution pattern of a filter element in accordance with the present disclosure. Pattern 280 can arrange the orifices 132, 232 in any desired arrangement. It will be appreciated that other arrangements can be used, including an X-Y grid pattern, a radial coordinate pattern, a pattern that spells out one or more characters, images or logos, and the like.

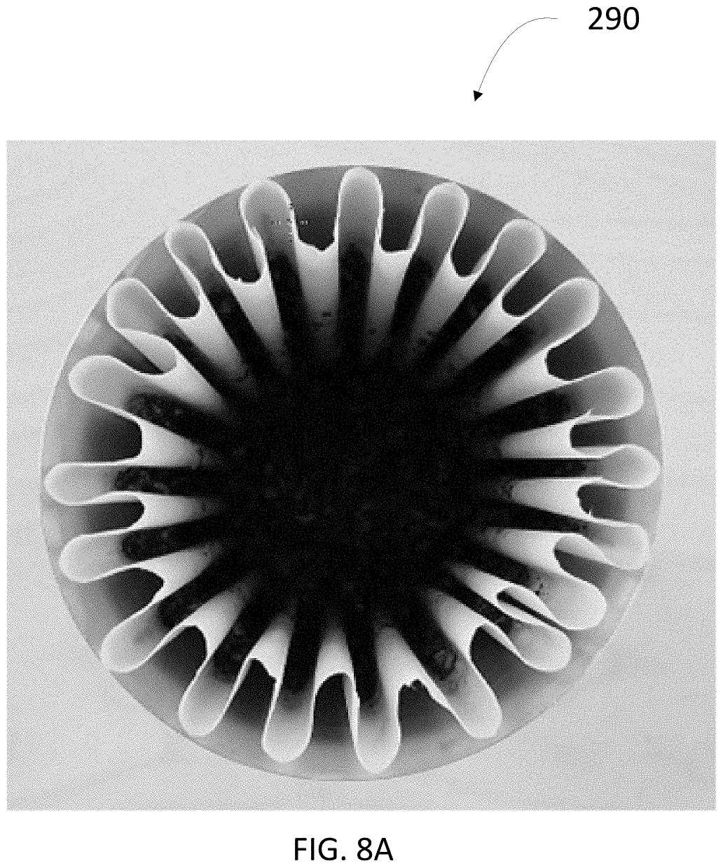

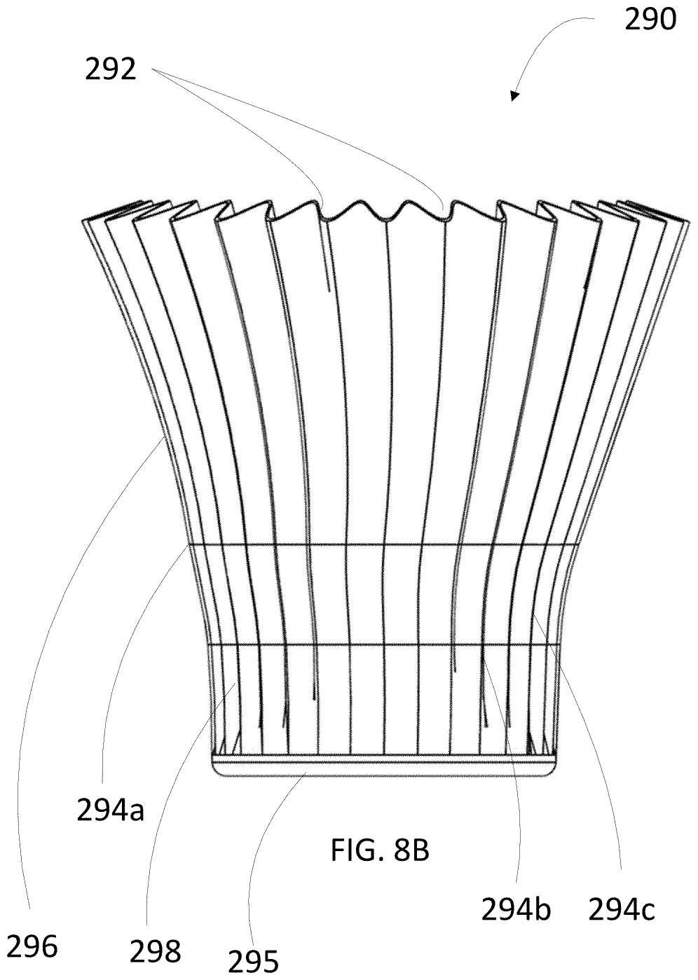

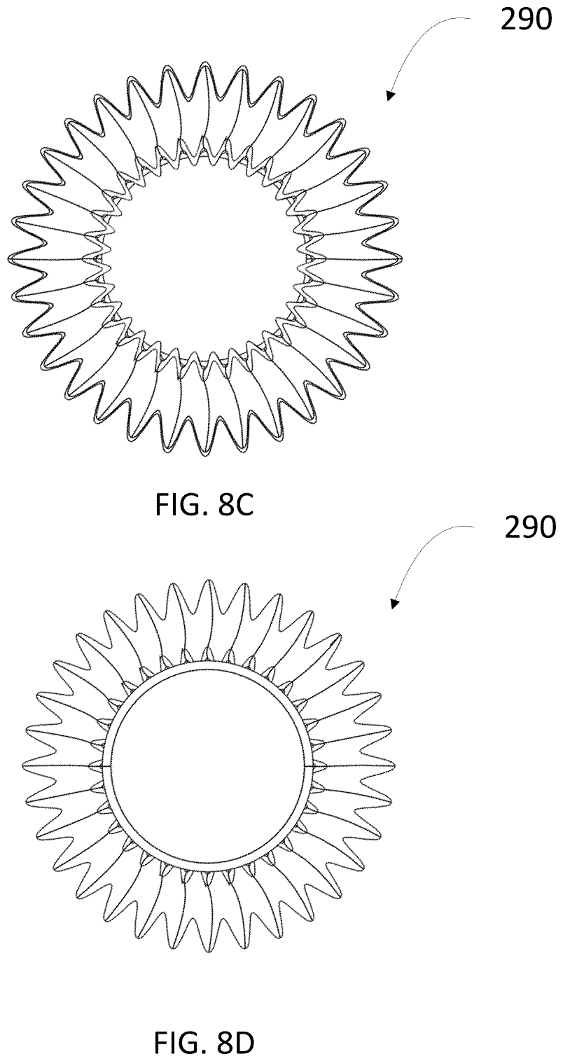

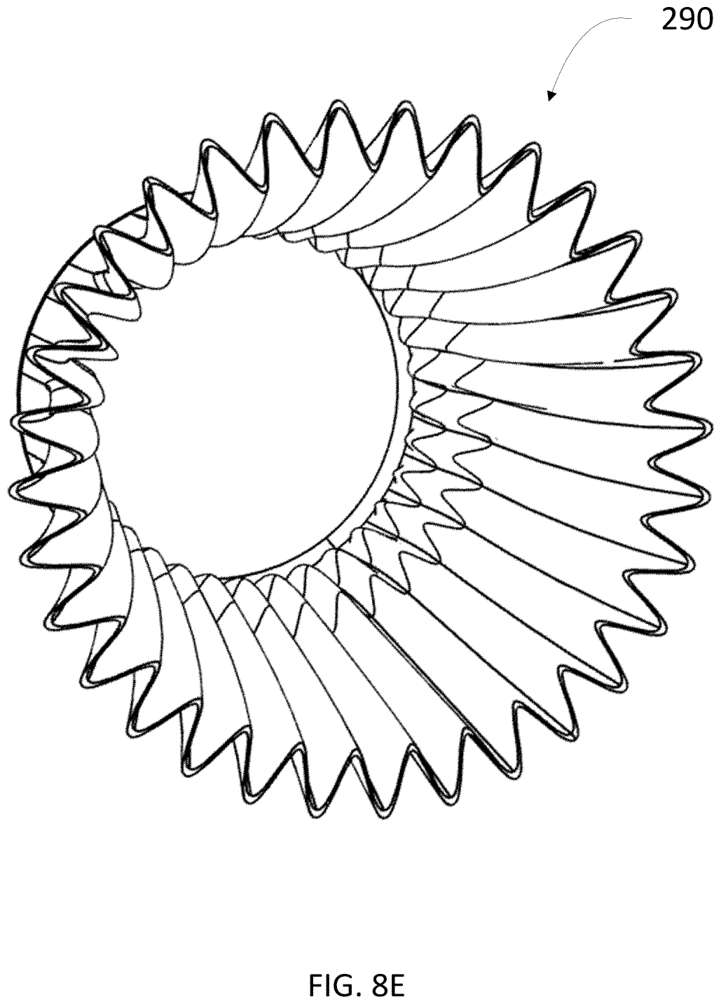

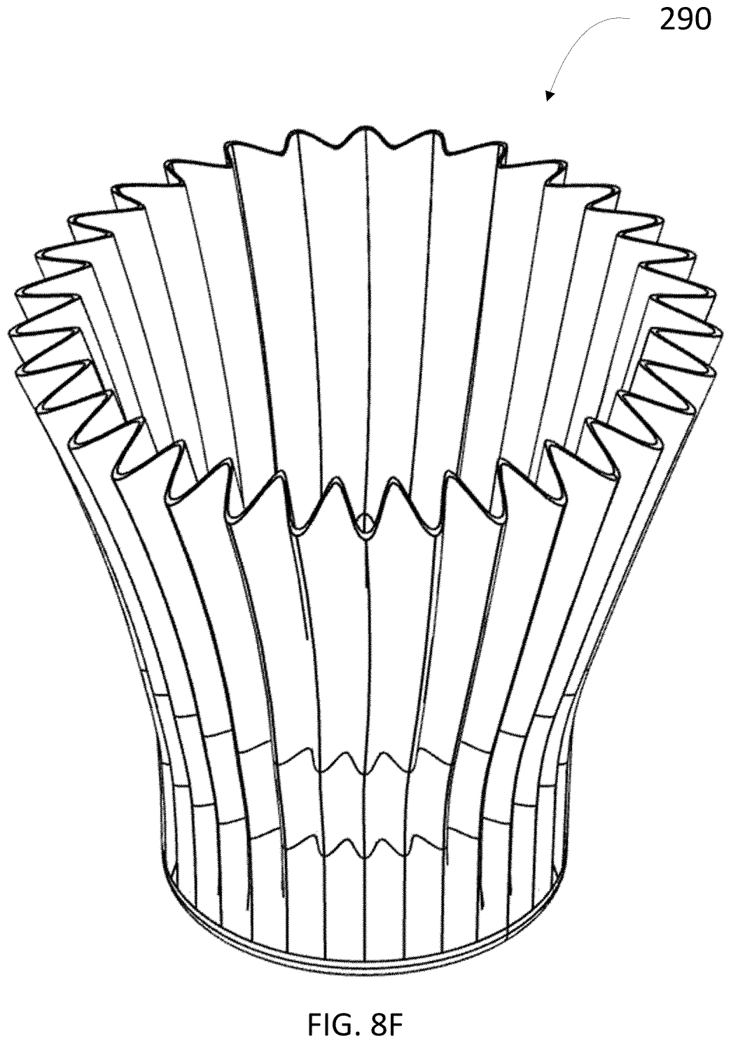

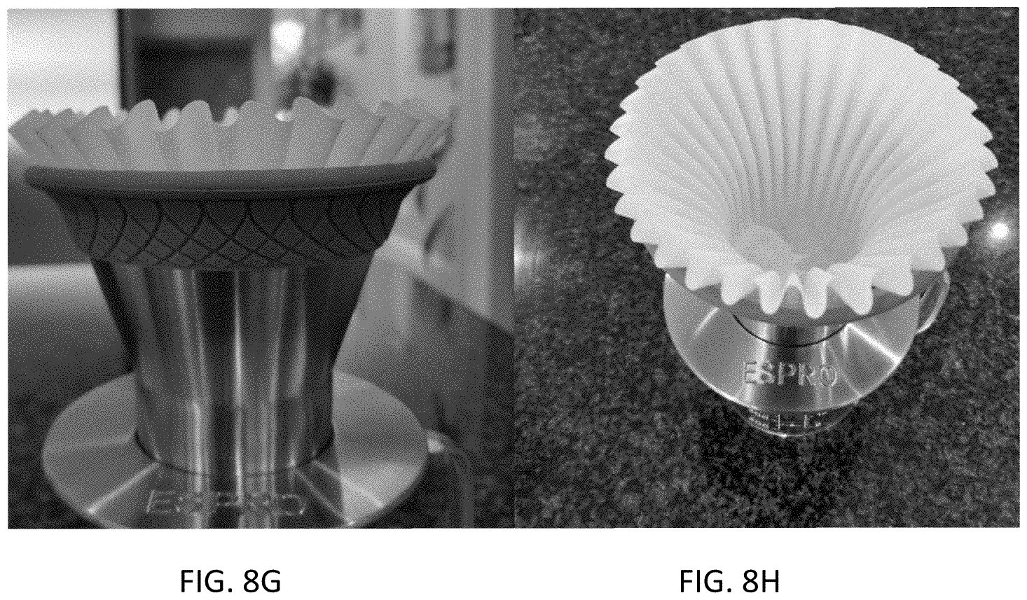

FIG. 8A is a top view of an embodiment of an infusion chamber in accordance with the present disclosure including a pleated filter element 290 disposed therein having infusible material. Filter element 290 preferably has a large number of pleats 292 in order to prevent their collapse and to help maintain structural stability of the filter element 290 in use. For example, filter element 290 preferably has between about 12 and 60 pleats, or any number of pleats therebetween as expressed by integers (13, 14, 15 . . . 59, 60). FIGS. 8B, 8C, 8D, 8E and 8F illustrate side plan, top plan, bottom plan, top interior isometric and side exterior isometric views of the filter element. Further views of the illustrated filter element can be seen in U.S. patent application Ser. No. 29/715,468. As illustrated, the filter element 290 is illustrated having 32 pleats, but any desired number of pleats can be used. The filter element can have a lateral projection, as depicted in FIG. 8B exhibits a concavity along the lateral side progressing from the top of the filter element to the bottom of the filter element. As illustrated, the side plan view, or side projection, or lateral projection of the filter element can have a longitudinal edge described by a first straight generally vertical portion that extends upwardly from the base 295 of the filter portion to define a generally cylindrical region 298 that adjoins a transition region 294 that begins at an inflection point (denoted by line 294b) where the longitudinal edge continues to travel upward and begins to curve radially outwardly. The transition region 294 terminates at a second inflection point (denoted by line 294a) where the longitudinal edge extends along a straight direction upwardly and radially outwardly to form a bell or flared region 296 that terminates in an undulating upper peripheral edge. As such, the filter element can be provided in a shape that is not entirely that of a conic section. For example, the shape can be bell shaped, a hyperboloid, and the like. Due to the illustrated shape, the filter element can be pre-shaped to match the contours of the illustrated brewer mechanism, such that the shape of the filter paper partially or fully follows the shape of the brewer from the bottom 295 of the filter paper to the top of the filter paper. Thus, while the filter element can have a straight longitudinal edge in a lateral projection, it may have a non-linear shape, such as an at least partially concave shape as illustrated, or a convex shape, or a combination of the two (e.g., undulating) as desired. The filter element can be manufactured from a variety of materials including paper and/or polymer, for example. During manufacture, the predetermined shape can be made by over-setting the shape (e.g., with a more extreme curvature than desired) in the event that some of the curvature is lost in later parts of the manufacturing process of the filter element.

FIG. 8G-8H illustrate aspects of the interaction between a thermal sleeve as illustrated in FIGS. 12A-12B disposed on the system illustrated in FIG. 1B and a flared filter element. Specifically, Applicant has come to appreciate that the flared filter element tends to spring upwardly and partially push itself out of the brewing apparatus. This can be mitigated by the thermal sleeve depicted in FIGS. 12A-12B, or any such thermal sleeve with a gripping surface that tends to mechanically trap the filter paper. The thermal sleeve of FIGS. 12A-12B includes an upper peripheral edge having a generally round cross section that has an inner face that is urged against by the flared filter element, tending to trap the filter element in place. This effect may also be accomplished by disposing a ring of silicone or other material with a gripping surface around the inner periphery of the brewer, or by providing a clip or other retainer to hold the filter paper in place prior to placing coffee grounds in the filter paper. Use of a filter paper with a continuous linear paper that is sufficiently shallow in angle tends to not push itself out of the brewer, at the expense of not matching the contour of the brewer as closely as the flared filter element.

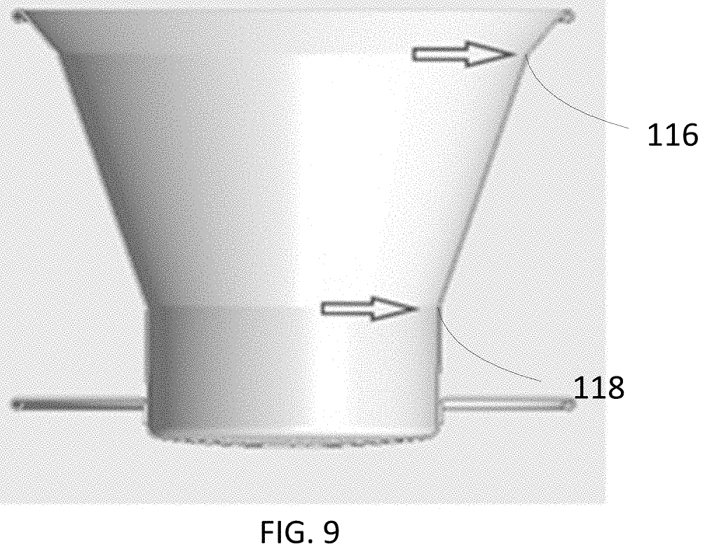

FIG. 9 is a cross sectional view of the embodiment of FIG. 1 illustrating indicia 116, 118 formed into the illustrated infusing container in accordance with the present disclosure. The lower indicia 118 can be used as a fill line for the amount of infusible material to place in the infusing container, and the upper indicia 116 can indicate the fill line for water, for example.

Any desired second or receiving container can be used, such as growlers, thermoses, flasks, beakers, cups, mugs, and the like. In some embodiments, the receiving container can be made from a transparent, translucent, and/or opaque material. The material of the receiving container itself can include a glass, a polymer, a ceramic, and/or a metal, for example.

The second container can be reusable or disposable, as desired. The second container can have any desired shape, including at least partially cylindrical, or can have a horizontal cross section along at least a part of its length that is rectangular (e.g., square), pentagonal, hexagonal, or the like. The second container can be provided with a flat base, an indented base, or a petaloid base (having one or more bosses, 3, 5, 7, etc.), for example. The second container in some embodiments can include a re-sealable or re-closable bag, pouch, or other flexible container that is opaque or translucent or transparent. In another embodiment, the receiving container is a travel cup or travel mug that can include an enhanced thermal mass. FIG. 11 is a cross sectional view of the embodiment of FIG. 1 having a rolled atraumatic peripheral edge.

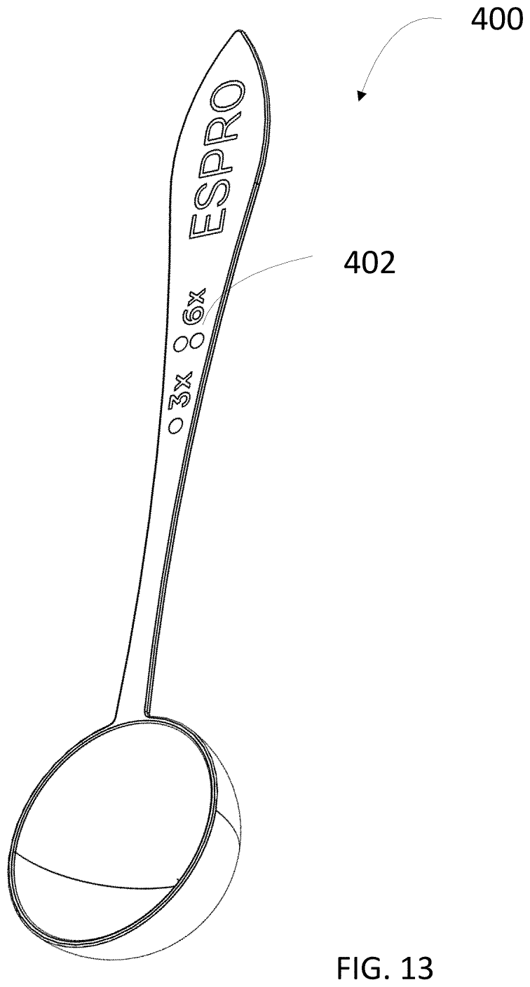

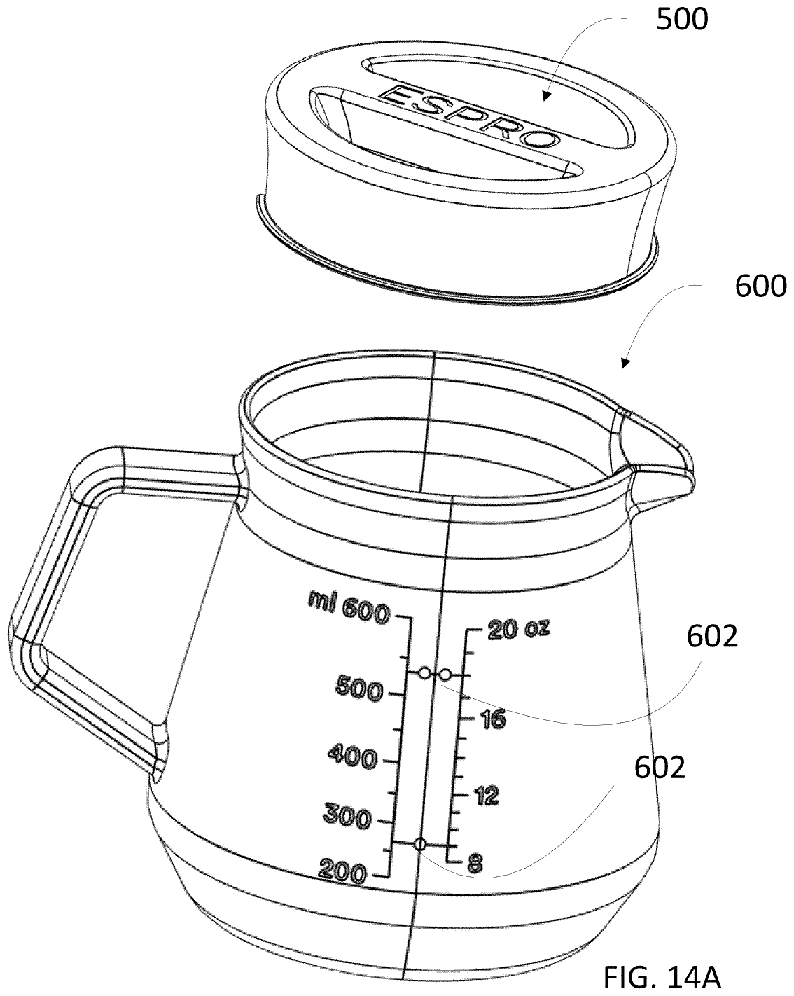

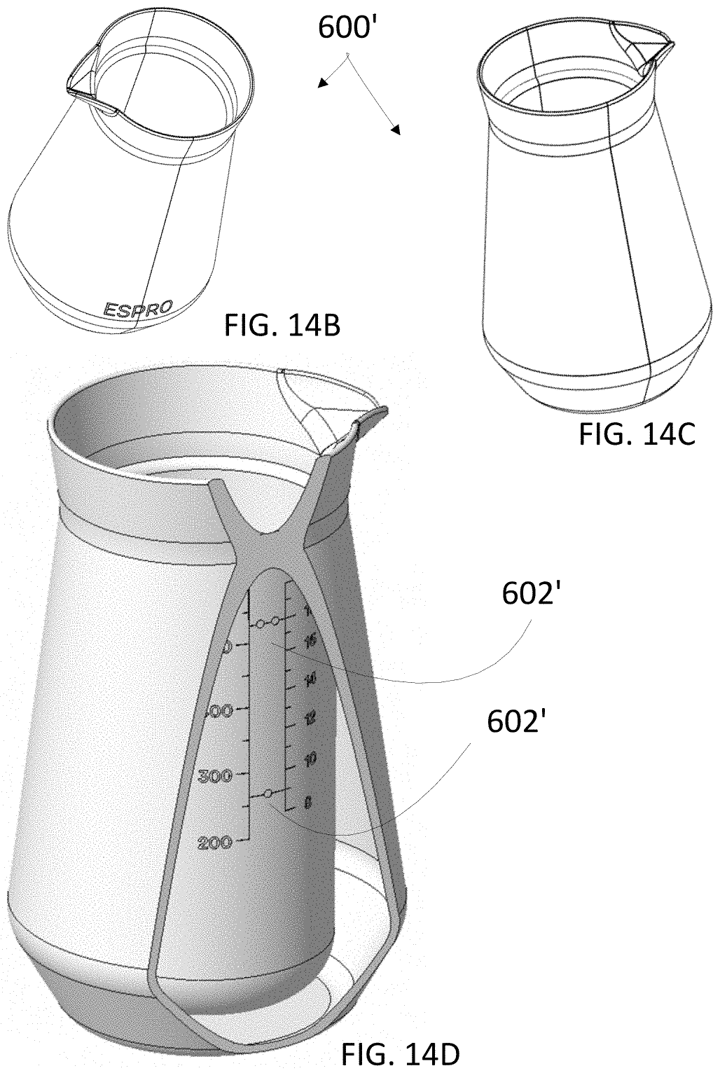

FIG. 14A illustrates a side isometric view of a single wall container or carafe 600 for receiving infused extract from a brewing device, such as that set forth herein. As illustrated, the container includes indicia 602 formed on a sidewall thereof, wherein the indicia includes a recipe, or instructions, for preparing pour over brew coffee of a desired strength. As an illustrative example, the lowest positioned indicia on the sidewall depicted in FIG. 14A includes a single circle for filling water. Matching indicia 402 in the form of a single circle is provided on a measuring scoop 400 depicted in FIG. 13. In this case, the indicia 402 provides instructions to fill the brewer with three scoops of coffee (e.g., level or heaping), corresponding to the single circular indicia. The container 600 is correspondingly filled to the lower single circular visual indicia with water, which can then be heated and poured over the coffee in the brewer. Likewise the double marked indicia on the scoop instructs a user to place six scoops of ground coffee into the brewer, and use an amount of water corresponding to the double indicia on the carafe. The indicia 602 on the carafe can be located on an outer surface of the carafe 602, as depicted. With reference to FIGS. 14B-D, a double walled carafe is depicted that can be provided with or without a handle, as desired. In this embodiment, the outer wall of the carafe 600′ may be transparent or translucent to permit visual perception of indicia 602′ formed on the outer surface of the inner wall of the vessel, as indicated by the cutaway view of FIG. 14D that removes a portion of the outer vessel. If desired, the outer shell can simply be provided with a transparent or translucent portion, such as a window, that permits viewing of the indicia formed on the outwardly facing surface of the inner wall of the carafe 600′.

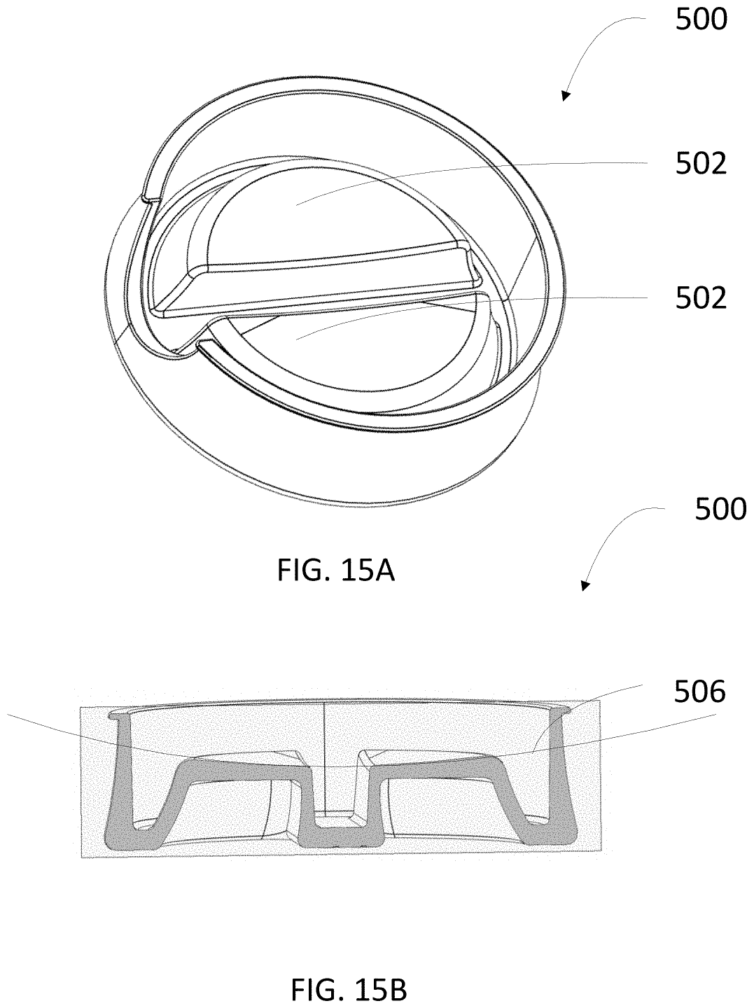

FIGS. 14A and 15A-15B depict aspects of a lid or cover 500 for the carafe 600, wherein the lid can be received by an open top of the container or carafe 600. FIG. 15A depicts the underside of the lid 500, which depicts two raised bosses 502 separated by a linear groove bisecting the lid, and surrounded by a peripheral annular trench. As depicted in the cross section FIG. 15B, the bosses 502 of the lid 500 are formed with a concave dish shape as prescribed by line of curvature 506 that is configured to match the convex lower surface of the brewer. Thus, the brewer can be placed on the surfaces formed by bosses 502 with the lid 500 inverted after the brewer is used on top of a container such as a cup, in order to capture any drips that continue to come out of the brewer.

It will be appreciated that a variety of alternatives in materials, construction techniques, configurations, shapes and the like can be made to any of the embodiments disclosed herein. For example, any feature discussed with respect to any embodiment of the infusing system, including but not limited to alignment structures and valves, may be suitably incorporated into any other embodiment of the infusing system. It will also be appreciated that the brewing reservoir of any disclosed embodiment can be configured so as to not actually touch the receiving container. Thus, while the present disclosure herein has been described with reference to particular preferred embodiments thereof, it is to be understood that these embodiments are merely illustrative of the principles and applications of the disclosure. Therefore, modifications may be made to these embodiments and other arrangements may be devised without departing from the spirit and scope of the disclosure.

What is claimed is:

1. A pour-over infusing container for making an infused extract from at least one liquid and at least one infusible material, comprising at least one peripheral wall that surrounds and at least partially defines an infusing chamber to hold a mixture of said at least one liquid and said at least one infusible material, a fluid entrance pathway for said liquid to enter said infusing chamber, and a fluid exit pathway for an infused extract to exit the infusing container, wherein said at least one peripheral wall includes an inner peripheral wall and an outer peripheral wall separated by a gap along at least a portion of their extent.

2. The pour-over infusing container of claim 1, wherein said gap includes an air filled gap.

3. The pour-over infusing container of claim 2, wherein said air filled gap functions as a dead air space.

4. The pour-over infusing container of claim 3, wherein said gap includes a dielectric material.

5. A pour-over infusing container for making an infused extract from at least one liquid and at least one infusible material, comprising at least one peripheral wall that surrounds and at least partially defines an infusing chamber to hold a mixture of said at least one liquid and said at least one infusible material, a fluid entrance pathway for said liquid to enter said infusing chamber, and a fluid exit pathway for an infused extract to exit the infusing container, wherein the peripheral wall includes at least one bend location that acts as an indicia for filling the infusing container with either infusible material or liquid.

6. The pour-over infusing container of claim 5, wherein the peripheral wall includes a plurality of bend locations that act as an indicia for filling the infusing container with either infusible material or liquid.

7. The pour-over infusing container of claim 5, wherein the peripheral wall of the infusing container includes a lower portion that transitions into a transverse filter element defining a plurality of openings therethrough, and an upper outwardly tapering portion that terminates in an upper peripheral opening of the infusing container.

8. The pour-over infusing container of claim 5, further comprising a filter paper disposed therein including a plurality of peripheral flutes.

9. The pour-over infusing container of claim 8, wherein the filter paper includes more than about twenty peripheral flutes.

10. A pour-over infusing container for making an infused extract from at least one liquid and at least one infusible material, comprising at least one peripheral wall that surrounds and at least partially defines an infusing chamber to hold a mixture of said at least one liquid and said at least one infusible material, a fluid entrance pathway for said liquid to enter said infusing chamber, and a fluid exit pathway for an infused extract to exit the infusing container, wherein the fluid exit pathway includes a filter element defining a plurality of orifices therethrough to permit the flow of infused extract therethrough, wherein the plurality of orifices are tapered along their length such that they have an increasing or decreasing cross sectional area from an entry opening to an exit opening thereof.

11. The pour-over infusing container of claim 10, wherein the plurality of orifices are tapered along their length such that they have an increasing cross sectional area from an entry opening to an exit opening thereof.

12. The pour-over infusing container of claim 11, wherein the plurality of orifices are configured to accelerate fluid flow therethrough by surface tension at a bottom surface of the filter element applying an enhanced drawing force to fluid passing through the filter element.

13. The pour-over infusing container of claim 11, wherein the plurality of orifices define a volume shaped as a conic section.

14. The pour-over infusing container of claim 10, wherein the plurality of orifices have a rounded cross section.

15. The pour-over infusing container of claim 10, wherein the plurality of orifices have a polygonal cross section.

16. The pour-over infusing container of claim 10, wherein the plurality of orifices define a plurality of sizes.

17. The pour-over infusing container of claim 10, wherein the plurality of orifices occupy more than about three percent of a planar area of the filter element.

18. The pour-over infusing container of claim 10, wherein the plurality of orifices occupy more than about five percent of a planar area of the filter element.

19. The pour-over infusing container of claim 10, wherein the plurality of orifices occupy more than about ten percent of a planar area of the filter element.

20. The pour-over infusing container of claim 10, wherein the further filter element follows the surface of the brewer, and further wherein the overall shape of the peripheral wall is not a conic section or cylindrical.
